(19) United States
(12) Patent Application Publication
(10) Pub. No.: US 2026/0067243 A1
(43) Pub. Date: Mar. 5, 2026

(54) INFORMATION PROCESSING METHOD, APPARATUS, AND ELECTRONIC DEVICE

(71) Applicant: Beijing Zitiao Network Technology Co., Ltd., Beijing (CN)

(72) Inventor: Qing ZENG, Beijing (CN)

(21) Appl. No.: 19/266,036

(22) Filed: Jul. 10, 2025

(30) Foreign Application Priority Data
Aug. 30, 2024 (CN) 202411217750.4

(51) Int. Cl. H04L 51/10; G06F 40/35; H04L 51/02; H04L 51/04

(52) U.S. Cl. CPC H04L 51/10; G06F 40/35; H04L 51/02; H04L 51/04

(57) ABSTRACT

The embodiments of the present disclosure provide an information processing method, an apparatus, and an electronic device. The method includes: displaying a reply message sent by a virtual contact in response to a question message sent by a user to the virtual contact, wherein the reply message includes reply content for the question message and a citation identification, located in the reply content, of citation content used to generate the reply content; and displaying the citation content indicated by the citation identification in response to a first preset operation performed on the citation identification.

### CROSS-REFERENCE TO RELATED APPLICATION(S)

The present application claims priority to Chinese Patent Application No. 202411217750.4, filed with the China National Intellectual Property Administration on Aug. 30, 2024 and entitled “information processing method, apparatus, and electronic device”, which is incorporated herein by reference in its entirety.

### FIELD

Embodiments of the present disclosure relate to the field of computer and internet technologies, and in particular, to an information processing method and apparatus, and an electronic device.

### BACKGROUND

With the popularization of internet and knowledge, users can obtain required knowledge from the internet. For example, a terminal initiates a question message, and a server sends related knowledge information obtained from the internet to users for browsing.

### SUMMARY

Embodiments of the present disclosure provide an information processing method and apparatus, and an electronic device.

In a first aspect, an embodiment of the present disclosure provides an information processing method, including: displaying a reply message sent by a virtual contact in response to a question message sent by a user to the virtual contact, where the reply message includes reply content for the question message and a citation identification, located in the reply content, of citation content used to generate the reply content; and displaying the citation content indicated by the citation identification in response to a first preset operation performed on the citation identification.

In a second aspect, an embodiment of the present disclosure provides an information processing apparatus, including: a first display unit, configured to display a reply message sent by a virtual contact in response to a question message sent by a user to the virtual contact, where the reply message includes reply content for the question message and a citation identification, located in the reply content, of citation content used to generate the reply content; and a second display unit, configured to display the citation content indicated by the citation identification in response to a first preset operation performed on the citation identification.

In a third aspect, an embodiment of the present disclosure provides an electronic device, including: a processor and a memory;

Where the memory stores computer-executable instructions; and

The processor executes the computer-executable instructions stored in the memory to enable the at least one processor to execute the method according to the above first aspect and various possible designs of the first aspect.

In a fourth aspect, an embodiment of the present disclosure provides a computer-readable storage medium, where the computer-readable storage medium stores computer-executable instructions, and when the processor executes the computer-executable instructions, the method according to the above first aspect and various possible designs of the first aspect is implemented.

In a fifth aspect, an embodiment of the present disclosure provides a computer program product, including a computer program, where when the computer program is executed by a processor, the method according to the above first aspect and various possible designs of the first aspect is implemented.

According to the information processing method and apparatus, and the electronic device provided in the embodiment, the reply message sent by the virtual contact is displayed in response to the question message sent by the user to the virtual contact, where the reply message includes the reply content for the question message and the citation identification, located in the reply content, of the citation content used to generate the reply content; and the citation content indicated by the citation identification is displayed in response to the first preset operation performed on the citation identification, so that a user can conveniently browse the citation content, and a requirement of the user for quickly obtaining the citation content can be satisfied.

### BRIEF DESCRIPTION OF THE DRAWINGS

To illustrate the technical solutions in the embodiments of the present disclosure or in the prior art more clearly, the following briefly introduces the drawings required for describing the embodiments or the prior art. Apparently; the drawings in the following description show some embodiments of the present disclosure, and a person of ordinary skill in the art may still derive other drawings from these drawings without creative efforts.

FIG. 1 is a first flowchart of an information processing method according to an embodiment of the present disclosure;

FIG. 2 is a second flowchart of an information processing method according to an embodiment of the present disclosure;

FIG. 3A is a schematic diagram of an application scenario;

FIG. 3B is a schematic diagram of an application scenario;

FIG. 3C is a schematic diagram of an application scenario;

FIG. 4A is a schematic diagram of an application scenario;

FIG. 4B is a schematic diagram of an application scenario;

FIG. 4C is a schematic diagram of an application scenario;

FIG. 5 is a third flowchart of an information processing method according to an embodiment of the present disclosure;

FIG. 6A is a schematic diagram of an application scenario;

FIG. 6B is a schematic diagram of an application scenario;

FIG. 6C is a schematic diagram of an application scenario;

FIG. 7A is a schematic diagram of an application scenario;

FIG. 7B is a schematic diagram of an application scenario;

FIG. 7C is a schematic diagram of an application scenario;

FIG. 8 is a schematic structural diagram of an information processing apparatus according to an embodiment of the present disclosure; and

FIG. 9 is a schematic structural diagram of an electronic device according to an embodiment of the present disclosure.

### DETAILED DESCRIPTION OF EMBODIMENTS

To make objectives, technical solutions, and advantages of embodiments of the present disclosure clearer, the following clearly and comprehensively describes the technical solutions in the embodiments of the present disclosure with reference to the drawings in the embodiments of the present disclosure. Apparently; the described embodiments are merely a part rather than all of embodiments of the present disclosure. All other embodiments obtained by a person of ordinary skill in the art based on the embodiments of the present disclosure without creative efforts shall fall within the protection scope of the present disclosure.

An intelligent assistant client may be run on a user terminal device. The user may initiate a question to the intelligent assistant client in work and life, and the intelligent assistant server replies to the question through related content in a network. For example, the intelligent assistant server may send content of the question to a language processing model, and the language processing model generates reply content. In the process of generating the reply content, the language model may use the related content to generate reply content. In an example, the reply content does not include information about the related content (the related content here may be considered as citation content). In this example, the user does not know the existence of the citation content, and therefore cannot browse the information about the citation content.

In another example, the information about the citation content is displayed at the end of the reply content. For example, a title of the citation content and a link corresponding to the citation content are displayed at the end of the reply content. In the process of browsing the reply content, if the user needs to browse the information about the citation content, the user needs to scroll to the end of all the reply content, and then open a details page corresponding to the citation content by triggering the link of the citation content.

Therefore, the above examples are not conducive to the user browsing the information about the citation content in the process of browsing the reply content, and cannot meet the requirement of the user for quickly obtaining the information about the citation content.

According to the solution provided in the embodiment of the present disclosure, the citation identification is set in the reply content, and the preview information of the citation content is displayed through the operation on the citation identification, so that the user can conveniently browse the information about the citation content, and the requirement of the user for quickly obtaining the information about the citation content can be satisfied.

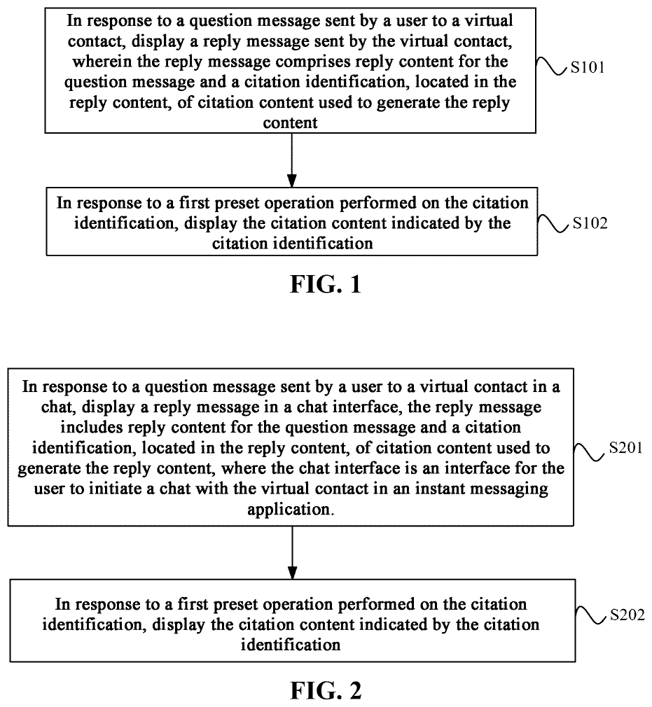

Referring to FIG. 1. FIG. 1 is a first flowchart of an information processing method according to an embodiment of the present disclosure. The method in this embodiment may be applied to a terminal device or a server, and the information processing method includes the following.

S101: A reply message sent by a virtual contact is displayed in response to a question message sent by a user to the virtual contact, where the reply message includes reply content for the question message and a citation identification, located in the reply content, of citation content used to generate the reply content.

The virtual contact may be at least one of the following: an intelligent assistant in application software or a chat robot in application software, and the intelligent assistant or the chat robot may reply to the received question through artificial intelligence or a large language model. The user may send a question message to the virtual contact. The question message here may be a question message for obtaining knowledge content.

Exemplarily, the user may send the question message to the virtual contact in a chat interface with the virtual contact. The question message may include one or more of text, a graphic, a picture, and voice.

The virtual contact may send the question message to a server, and the server invokes a language processing model to process the question message.

The citation content here refers to content cited to generate the reply content. The citation content may include some content from a network, such as text, a graphic, an image, or a video.

As an implementation, the server may first obtain a plurality of pieces of citation content related to the question message from the network, then input the question message and the plurality of pieces of citation content into the language processing model, and the language processing model generates the reply content for the question message according to the citation content. The server may obtain the reply content from the language processing model. In addition, the language processing model may give information about the citation content referred to by different parts of the reply content. The server may generate the reply message according to the reply content and the information about the citation content referred to by different parts of the reply content.

The server of the virtual contact may send the reply message to a client, and after receiving the reply message, the client may instruct an execution body to display the reply message.

The citation identification of the citation content may be set in the reply content, for example, embedded in a sentence of the reply content. Specifically, in the reply content, the citation identification of the citation content may be displayed in a subscript or superscript manner in words and sentences obtained from the citation content. The citation identification may be any identification indicating the citation content. Exemplarily, the citation identification may include one or more of a numeral, a letter, or a word. Exemplarily, the citation identification corresponding to each piece of citation content may be represented by a numeral.

In some implementations, the reply content includes at least one first sentence, the first sentence is generated according to corresponding citation content, and for each first sentence, a citation identification of the citation content corresponding to the first sentence is located at a preset position of the first sentence:

Alternatively, the reply content includes at least one first paragraph, the first paragraph is generated according to corresponding citation content, and for each first paragraph, a citation identification of the citation content corresponding to the first paragraph is located at a preset position of the first paragraph.

In some application scenarios, the reply content may include a plurality of sentences, where the plurality of sentences may include one or more first sentences generated according to the citation content. For each first sentence, an identification of the citation content for generating the first sentence is displayed at a preset position of the first sentence, such as at the beginning or end of the first sentence. In these implementations, the citation identification of the sentence-related citation content is displayed in the dimension of the sentence, so that the user can conveniently browse the information about the citation content after the first sentence.

In some application scenarios, the reply content may include a plurality of paragraphs, where the plurality of paragraphs may include one or more first paragraphs generated according to the citation content. For each first paragraph, a citation identification of the citation content of the first paragraph is displayed at a preset position of the first paragraph, such as at the beginning or end of the first paragraph. In these implementations, the citation identification of the paragraph-related citation content is displayed in the dimension of the paragraph, and the user can read the entire paragraph coherently and then view the information about the paragraph-related citation content as required.

S102: The citation content indicated by the citation identification is displayed in response to a first preset operation performed on the citation identification.

The first preset operation may be any operation indicating display of the citation content, for example, may include operations such as clicking, cursor hovering, or touching. After receiving the first preset operation performed on the citation identification, the citation content may be displayed.

In some implementations, the displaying the citation content indicated by the citation identification includes:
Displaying preview content of the citation content in the form of a card; or
Displaying the citation content in the form of a pop-up window or a floating window.

The preview content displayed in the form of a card or the pop-up window or floating window may cover an interface where the question message or the reply message is located. In this way, the citation content is displayed while the reply message is displayed, which facilitates the user to browse the reply message and the citation content.

The preview content of the citation content includes but is not limited to one or more of the following:

A type mark, a theme, citation content, or an information browsing entry.

The type mark here may be a mark of a type to which the citation content belongs. If the type of one piece of citation content is a document, a document mark may be displayed in the preview content. The document mark may include various preset marks used to characterize a document type.

If the type of one piece of citation content is a chat, a chat mark may be displayed in the preview content of the citation content. The chat mark may include various preset marks used to characterize a chat type.

The theme here may be a theme of the citation content. If one piece of citation content is a document, the theme of the citation content may be a title of the document. For another example, if one piece of citation content is a chat, the theme of the citation content may be a theme of the chat.

The citation content may be a snapshot or a thumbnail of the citation content.

The information browsing entry here may be an entry for opening a web page where the citation content is located.

In this embodiment, the citation identification is set in the reply content, and the preview information of the citation content indicated by the citation identification is displayed according to the first preset operation performed by the user on the citation identification. Therefore, the user can browse the citation content by performing a preset operation on the citation identification in the reply content, so that a new channel is provided for the user to obtain the citation content, the efficiency of obtaining the citation content by the user can be improved, and the convenience of obtaining the citation content by the user is improved. In other words, a new channel is provided for the user to acquire the citation content, the efficiency of the user in acquiring the citation content can be improved, and the convenience of the user in acquiring the citation content is increased.

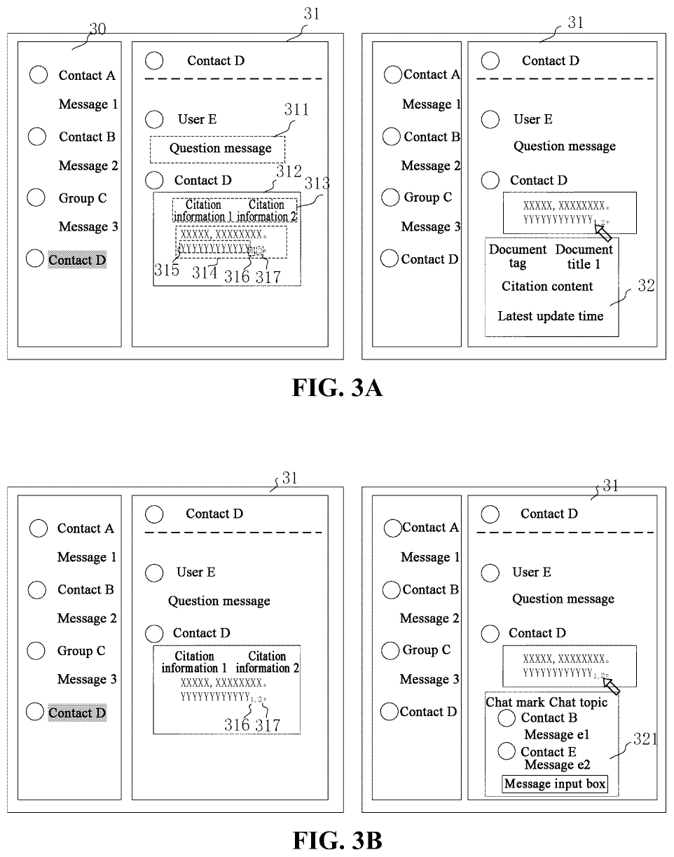

Referring to FIG. 2. FIG. 2 is a second flowchart of an information processing method according to an embodiment of the present disclosure. The method in this embodiment may be applied to a terminal device or a server, and the information processing method includes the following.

S201: A reply message in a chat interface is displayed in response to a question message sent by a user to a virtual contact in the chat, where the reply message includes reply content for the question message and a citation identification, located in the reply content, of citation content used to generate the reply content, and the chat interface is an interface for chatting with the virtual contact initiated by the user in an instant messaging application.

The instant messaging application here may be various applications that can implement an instant messaging function. In the instant messaging application, a user may have a plurality of contacts in a contact list. In some application scenarios, the contact list may be a contact list composed of a plurality of user group members of a user group to which the user belongs.

The virtual contact may be at least one of the following: an intelligent assistant in application software or a chat robot in application software, and the intelligent assistant or the chat robot may be used as a virtual contact of each user group member, and the user group member may initiate interaction with the virtual contact in the instant messaging application.

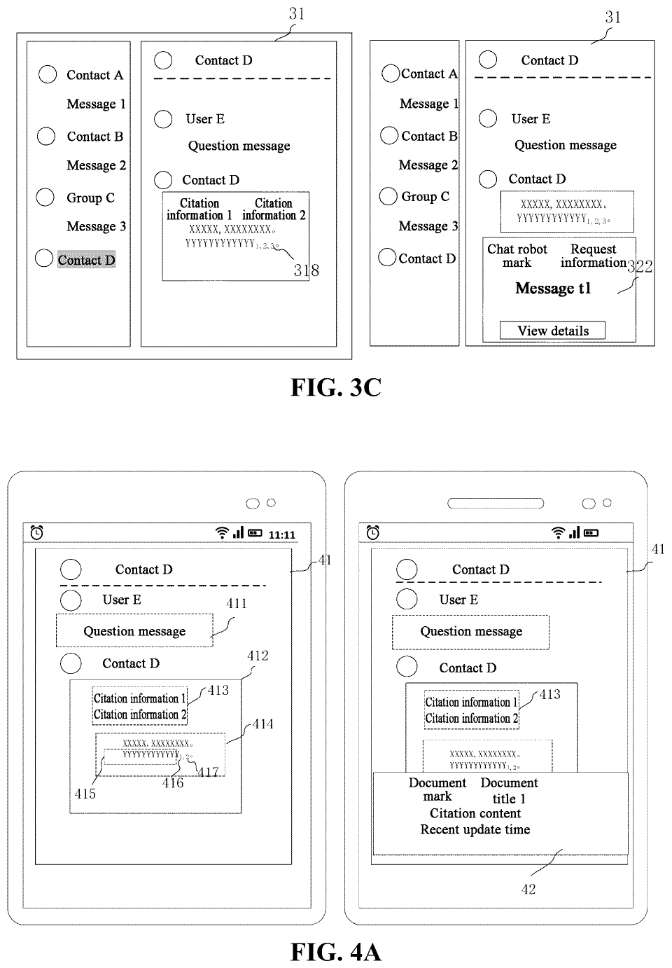

In some application scenarios, reference is made to FIG. 3A, which is a schematic diagram of an application scenario. A message flow 30 may be displayed in an interface of an instant messaging application, and the message flow 30 may include messages generated between a user and a plurality of contacts. For example, the latest message “message 1” between the user and a contact A, the latest message “message 2” between the user and a contact B, the latest message “message 3” of a group chat C in which the user participates, and a contact D are displayed. The contact D may be a virtual contact.

The user (such as a user E in FIG. 3A) may perform, in the message flow, a chat trigger operation with the virtual contact (the contact D), for example, click on an identification of the contact D to enter a chat interface 31 between the user and the contact D, and the user may send a question message 311 to the contact D in the chat interface 31.

The virtual contact (the contact D) may be an intelligent assistant client, and the virtual contact (the contact D) may reply according to the question information.

A reply message 312 of the virtual contact (the contact D) may be displayed in the chat interface 31, for example, displayed below the question message 311. The reply message 312 includes reply content 314 for the question message and citation identifications (such as citation identifications 316 and 317 in FIG. 3A) set in the reply content 314. One or more citation identifications may be included, and each citation identification indicates one piece of citation content.

S202: The citation content indicated by the citation identification is displayed in response to a first preset operation performed on the citation identification.

The first preset operation may be operations such as touching or clicking etc.

As an implementation, the preview content of the citation content may be displayed in the form of a card.

In some implementations, if the citation content is document content, the preview content includes: a document mark, a document title, document content for generating the reply content, and a latest update time;

If the citation content is message content of a chat with a contact, the preview content includes: a chat mark, a chat theme, and message content for generating the reply content; and

If the citation content is chat message content with a chat robot, the preview content includes: a chat robot mark, request information sent to the chat robot, and chat robot reply content used to generate the reply content.

As shown in FIG. 3A, the citation content indicated by the citation identification 316 is document content, and when the first preset operation performed by the user on the citation identification 316 is received, the preview content 32 of the citation content is displayed in the form of a card, where the preview content 32 may include a document mark, a document title 1, at least part of citation content used to generate the reply content, and the latest update time.

As shown in FIG. 3B, the citation content indicated by the citation identification 317 is message content of a chat with a contact B, and when the first preset operation performed by the user on the citation identification 317 is received, the preview content 321 of the citation content is displayed in the form of a card. The preview content 321 includes: a chat mark, a chat theme, a message e1 sent by the contact B, and a message c2 sent by the user E. The message e1 and the message e2 here may be citation content.

As shown in FIG. 3C, the citation content indicated by the citation identification 318 is chat message content with a chat robot, and when the first preset operation performed by the user on the citation identification 318 is received, the preview content 322 of the citation content is displayed in the form of a card. The preview content includes: a chat robot mark, request information, and a message t1 provided by the chat robot. The message t1 here may be citation content.

In these implementations, the preview content of the target citation content corresponding to the target citation identification is displayed in the form of a card and the target citation identification is highlighted through the first preset operation performed on the target citation identification, so that the user can quickly browse the preview content and know which target citation identification the currently displayed preview content corresponds to.

In this embodiment, the virtual contact is used as a contact of the user in the instant messaging application. Since the instant messaging application is an application with the highest frequency of use by the user and is often in an open state, the virtual contact is used as a contact of the user in the instant messaging application, the user can open a chat interface with the virtual contact through the instant messaging application, send question information in the chat interface, and display a reply message in the chat interface with the virtual contact, without launching an intelligent assistant application or launching a web version of the intelligent assistant to obtain related knowledge, thereby facilitating the user to obtain the knowledge content.

In some optional implementations of the embodiment shown in FIG. 1 or FIG. 2, a plurality of pieces of citation content exist, and the reply message further includes a citation list, where the citation list includes citation information corresponding to the plurality of pieces of citation content respectively.

For any piece of citation content, the citation information of the citation content may include, for example, a citation identification of the citation content, a theme of the citation content, and the like.

The citation list may include citation information corresponding to the plurality of pieces of citation content respectively. Reference is made to FIG. 3A. A reply message 312 in FIG. 3A includes a citation list 313. The citation list 313 includes citation information 1 and citation information 2. The citation information 1 may include a citation identification 316 and a title of corresponding citation content S1, and the citation information 2 may include, for example, a citation identification 317 and a title of corresponding citation content S2. Exemplarily, the citation identification 316 may be 1, and the citation identification 317 may be 2.

The citation list is set in the reply message, so that the user can conveniently obtain an overview of the information about all the citation content used in the reply content.

In some optional implementations, the citation list is located above the reply content, and a plurality of pieces of citation information in the citation list are arranged horizontally or vertically in a preset order, where each piece of citation information corresponds to one piece of citation content.

In some application scenarios, the plurality of pieces of citation information in the citation list may be arranged horizontally, that is, the plurality of pieces of citation information may be located in the same row and displayed above the reply content. For example, in a desktop computer or a portable laptop, the plurality of pieces of citation information in the citation list are arranged in the same row in the preset order. As shown in FIG. 3A, the plurality of pieces of citation information “citation information 1” and “citation information 2” in the citation list 312 are arranged horizontally. The user can quickly browse the plurality of pieces of citation information in the reply message.

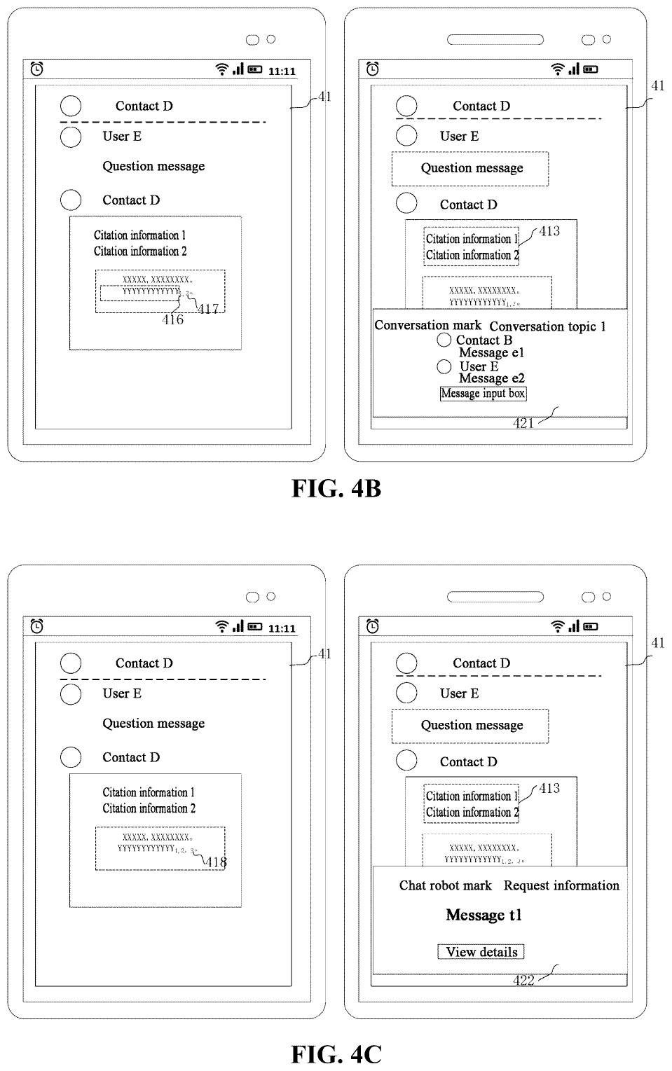

In some application scenarios, the plurality of pieces of citation information in the citation list are arranged vertically, that is, the plurality of pieces of citation information are arranged in a column and located above the reply content. For example, in a mobile terminal such as a mobile phone, the plurality of pieces of citation information in the citation list are arranged in a column and located above the reply content. Reference is made to FIG. 4A, which is a schematic diagram of an application scenario. As shown in FIG. 4A, a contact D may be a virtual contact in a contact list of a user E. The user E may initiate a chat with the contact D in the contact list, and then a chat page 41 is displayed. The user E may send a question message 411 to the contact D in the chat page 41. A reply message 412 of the contact may be displayed in the chat page 41. The reply message 412 includes a citation list 413. The citation list 413 includes a plurality of pieces of citation information arranged vertically. The plurality of pieces of citation information are, for example, citation information 1 and citation information 2 as shown in FIG. 4A.

As an implementation, the preset order may be, for example, the order in which the citation content is cited from the first sentence to the last sentence of the reply content. For example, in the reply content 414 in FIG. 4A, the citation content corresponding to the citation information 1 is cited before the citation content corresponding to the citation information 2, and the citation information 1 is set before the citation information 2 in the citation list.

In the above various application scenarios, different display styles for displaying the question message and the reply message are provided, so that the above solution can be applied to different display devices.

In these optional implementations, the citation list is set above the reply content, so that the user can quickly browse the information about the citation content referred to by the reply content.

In some optional implementations of the information processing method shown in FIG. 1 and FIG. 2, the reply content includes at least one first sentence, the first sentence is generated according to corresponding citation content, and for each first sentence, a citation identification of the citation content corresponding to the first sentence is located at a preset position of the first sentence:

Alternatively, the reply content includes at least one first paragraph, the first paragraph is generated according to corresponding citation content, and for each first paragraph, a citation identification of the citation content corresponding to the first paragraph is located at a preset position of the first paragraph.

In some application scenarios, the reply content may include one or more sentences, where the one or more sentences may include at least one first sentence. Each first sentence may be a sentence generated according to one or more pieces of citation content. The generating a sentence according to citation content may include using one sentence in the citation content as the first sentence, or generating the first sentence according to semantics of one or more paragraphs in the citation content.

For each first sentence, a citation identification of the one or more pieces of citation content for generating the first sentence may be set at a preset position of the first sentence. The preset position may be the beginning or end of the first sentence. Taking the preset position being the end of the sentence as an example, for each first sentence, the citation identification corresponding to the first sentence may be set at the end of the first sentence.

If the first sentence corresponds to a plurality of citation identifications, the plurality of citation identifications are all set at the end of the first sentence. For example, the plurality of citation identifications may be set at the end of the first sentence in a preset order.

In some application scenarios, the reply content may include one or more paragraphs, where the one or more paragraphs may include at least one first paragraph. Each first paragraph may be a paragraph generated according to one or more pieces of citation content. The generating a paragraph according to citation content may include generating the first paragraph according to semantics of one or more paragraphs of the citation content.

The preset position includes the beginning or end of a paragraph. For each first paragraph, a citation identification corresponding to the first paragraph may be set at the preset position of the first paragraph, for example, at the end of the first paragraph.

Reference is made to FIG. 4A. The reply message 412 further includes reply content 414. The reply content 414 may include a first sentence “YYYYYYYYYYYY” 415 generated according to citation content, and citation identifications 416 and 417 are displayed at the end of the first sentence 415. The citation identification 416 corresponds to citation information 1, and the citation identification 417 corresponds to citation information 2. The citation content corresponding to the citation information 1 is cited before the citation content corresponding to the citation information 2.

As shown in FIG. 4A, the citation content indicated by the citation identification 416 is document content, and when the first preset operation performed by the user on the citation identification 416 is received, the preview content 42 of the citation content is displayed in the form of a card from the bottom of the display interface, where the preview content may include a document mark, a document title 1, at least part of citation content used to generate the reply content, and the latest update time.

As shown in FIG. 4B, the citation content indicated by the citation identification 417 is message content of a chat with a contact B, and when the first preset operation performed by the user on the citation identification 417 is received, the preview content 421 of the citation content is displayed in the form of a card from the bottom of the display interface. The preview content includes: a chat mark, a chat theme, a message e1 sent by the contact B, and a message c2 sent by the user E. The message e1 and the message e2 here may be citation content.

As shown in FIG. 4C, the citation content indicated by the citation identification 418 is chat message content with a chat robot, and when the first preset operation performed by the user on the citation identification 418 is received, the preview content 422 of the citation content is displayed in the form of a card from the bottom of the display interface. The preview content includes: a chat robot mark, request information, and a message t1 provided by the chat robot. The message t1 here may be citation content.

In these implementations, the citation identification is displayed at the preset position of the first sentence or the first paragraph generated according to the citation content, so that the user can know which parts of the reply content are generated according to the citation content. Furthermore, the citation content indicated by the citation identification may be displayed through the first preset operation performed on the citation identification.

In some optional implementations. Step S102 in the embodiment shown in FIG. 1 and Step S202 in the embodiment shown in FIG. 2 include: displaying target citation content indicated by a target citation identification in response to a first preset operation performed on the target citation identification; and highlighting the target citation identification in the reply content.

In these optional implementations, the target citation identification may be a citation identification on which the first preset operation is performed. For example, the user may perform the first preset operation on any citation identification in the reply content, and the citation identification may be the target citation identification. After receiving the first preset operation performed on the target citation identification, the execution body of the information processing method may display the target citation content indicated by the target citation identification.

The target citation identification may be highlighted while the target citation content is displayed. The highlighting the target citation identification may include setting a display style of the target citation identification to be different from display styles of other citation identifications while the preview information is displayed. The display style includes a background color, a font style, a font size, a font color, and the like.

Reference is made to FIG. 3A. In FIG. 3A, the user may perform a cursor hover operation on the citation identification 316 in the reply content, and then the preview content 32 may be displayed in the form of a card, where the target citation content indicated by the target citation identification 316 may be displayed in the preview content 32. The target citation content corresponding to the target citation identification 316 is document content. The preview content may include a document mark, a document title 1 of the citation content, document content, and the latest update time of the document. In addition, the citation identification 316 is highlighted while the target citation content is displayed, for example, a display color of the citation identification 316 is set to be different from display colors of other citation identifications.

Reference is made to FIG. 4A. In FIG. 4A, the user may perform a first preset operation (such as a touch operation) on the target citation identification 416 in the reply content, and then the preview content 42 of the target citation content may be displayed in the form of a card from bottom to top in the chat interface 41. The citation content corresponding to the target citation identification 416 is document content of a document. The preview content 42 may include a document mark, a document title 1 of the citation content, a snapshot of the document content, and the latest update time of the document. In addition, the citation identification 416 is highlighted while the preview content is displayed, for example, a display color of the citation identification 416 is set to be different from display colors of other citation identifications.

In these implementations, the target citation content is displayed and the target citation identification is highlighted through the first preset operation performed on the target citation identification, so that the user can know which citation identification the currently browsed citation content corresponds to while browsing the target citation content.

In some optional implementations of the information processing method shown in FIG. 1 and FIG. 2, the method further includes the following steps:

Canceling displaying the preview content in response to a second preset operation performed outside the preview content; or

Canceling displaying the citation content in response to a second preset operation performed outside the pop-up window or floating window.

The second preset operation includes operations such as clicking and touching for indicating canceling displaying the preview information.

For example, the second preset operation performed by the user on an area outside the display region of the preview content is received, and the displaying the preview content is canceled. When the second preset operation performed by the user outside the area where the floating window or the pop-up window is located is detected, the displaying the citation content is canceled. In this way, the operation of canceling displaying the preview content or the citation content is simplified.

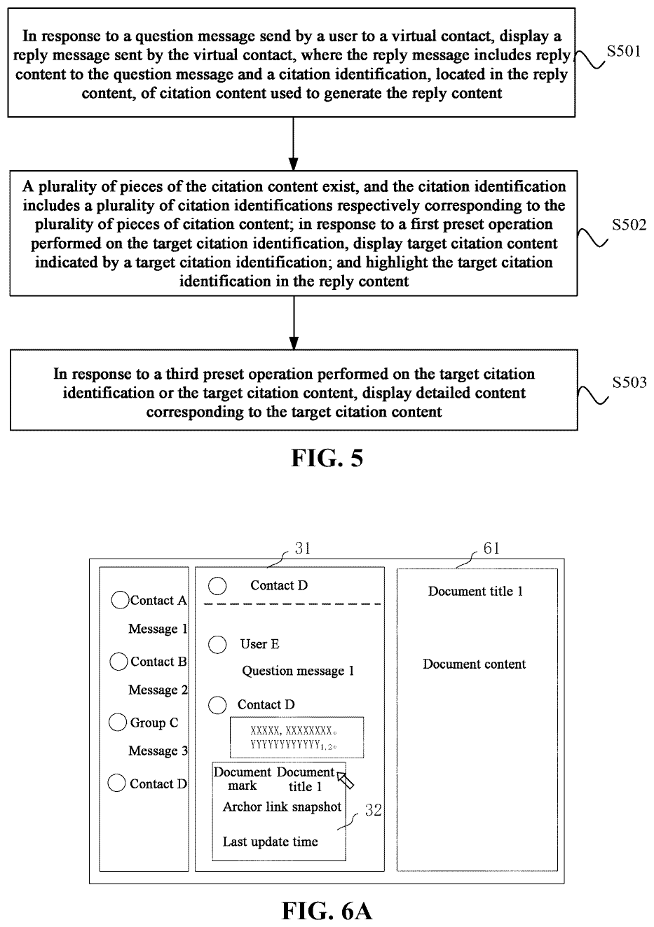

Reference is made to FIG. 5, which is a third flowchart of an information processing method provided by the present disclosure. As shown in FIG. 5, the method includes the following steps.

S501: A reply message sent by a virtual contact is displayed in response to a question message sent by a user to the virtual contact, where the reply message includes reply content for the question message and a citation identification, located in the reply content, of citation content used to generate the reply content.

For the specific implementation of Step S501, reference may be made to the description of Step S101 in the embodiment shown in FIG. 1. In some implementations, the virtual contact may be a contact of the user in a contact list of an instant messaging application. The question message and the reply message may be displayed in a chat interface between the user and the virtual contact in the instant messaging application.

S502: A plurality of pieces of citation content exist, and the citation identification includes citation identifications corresponding to the plurality of pieces of citation content respectively; target citation content indicated by a target citation identification is displayed in response to a first preset operation performed on the target citation identification; and the target citation identification in the reply content is highlighted.

The target citation identification may be any of the plurality of citation identifications.

The first preset operation here may be operations such as cursor hovering and touching.

The preview content displayed in the form of a card may cover an interface where the question message and the reply message are displayed.

S503: Detailed content corresponding to the target citation content is displayed in response to a third preset operation performed on the target citation identification or the target citation content.

The third preset operation is any operation for opening the detailed content corresponding to the target citation content, including but not limited to clicking, touching, and the like.

In some examples, the displaying the detailed content corresponding to the target citation content indicated by the target citation identification includes displaying all content corresponding to the target citation content, for example, including content related to the reply content and content not related to the reply content.

In some implementations, the user may perform the third preset operation on the target citation identification in the reply content, to trigger display of the detailed content corresponding to the target citation content indicated by the target citation identification. For example, the target citation identification is associated with a link of the detailed content corresponding to the target citation content, and after receiving the third preset operation performed on the target citation identification, the user may jump to the detailed content page of the target citation content according to the link.

In some implementations, the user may perform the third preset operation on the target citation content, to trigger display of the detailed content of the target citation content.

In some examples, the target citation content may be associated with a link of the detailed content corresponding to the target citation content. After receiving the trigger operation performed on the target citation content, the user may acquire, through the page link, the content of the page where the detailed content corresponding to the target citation content is located and display the content. When displaying the detailed content, the user may position to the location of the target citation content. In this way, the user can quickly browse the target citation content in the detailed content.

In some implementations, Step S503 includes: displaying the detailed content corresponding to the target citation content in a new window; or
displaying the detailed content corresponding to the target citation content in a new page, where the new page covers the page where the question message and the reply message are displayed.

In these implementations, the detailed content corresponding to the target citation content is displayed in the side window of the window where the question message and the reply message are displayed, or the detailed content corresponding to the target citation content is displayed in the new page covering the page where the question message and the reply message are displayed, so that different display manners may be selected according to different devices to which the solution is adapted, such that the solution can be adapted to different types of devices.

In some implementations, the citation content includes at least one of the following:
document content, message content of a chat with a contact, chat message content with a chat robot, or email content.

Correspondingly, the detailed content of the document includes a title, a plurality of paragraphs of the document, and a link of the document:

The detailed content of the chat with the contact includes a theme of the chat, a plurality of pieces of message content, and a message input box; and

The detailed content of the chat with the robot includes a plurality of pieces of message content of the chat with the robot, a plurality of resource classifications, where each resource classification corresponds to a plurality of pieces of resource information and a message input box.

In some application scenarios, the detailed content corresponding to the target citation content may be displayed in a new page, and the new page covers the page where the question message and the reply message are displayed.

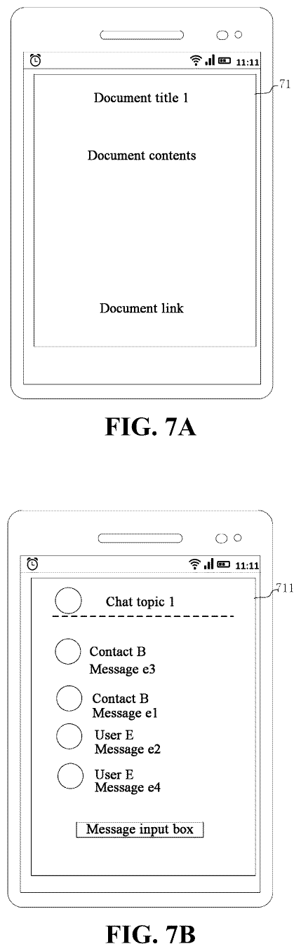

Reference is made to FIG. 4A and FIG. 7A, which is a schematic diagram of an application scenario. In an instant messaging application, a plurality of messages generated between a user and a virtual contact are displayed in a first page 41, that is, a question message 411 and a reply message 412 are displayed in the first page 41. The reply message 412 includes a citation list 413 and reply content 414. The reply content 414 includes a first sentence 415, and the first sentence 415 is generated according to citation content S1 and S2. Citation identifications 416 and 417 corresponding to the citation content S1 and S2 respectively are displayed at the end of the first sentence 415. The user may perform a third preset operation on the target citation identification 416, to open a second page 71. As shown in FIG. 7A, the detailed content corresponding to the target citation content S1 is displayed in the second page 71. The second page 71 covers the first page 41. For example, if the target citation content S1 is document content, a document title 1 of the document corresponding to the target citation content S1, detailed content, and a document link may be displayed in the second page 71.

Reference is made to FIG. 4B and FIG. 7B, which is a schematic diagram of an application scenario. As shown in FIG. 4B, a question message and a reply message are displayed in the first page 41. The reply message includes a citation list and reply content. The reply content includes a first sentence, and the first sentence is generated according to citation content S1 and S2. The citation content S2 in the first sentence is message content of a chat with a contact. A citation identification of the citation content S2 is 417. The user may perform a first preset operation on the target citation identification 417, and the preview content 421 of the target citation content S2 may be displayed in the form of a card. The user may perform a third preset operation on the preview content 421, to open a third page 711, as shown in FIG. 7B. The detailed content of the chat between the user E and the contact B is displayed in the third page 711, as shown in FIG. 7B, a chat theme, a message c3 and a message e1 sent by the contact B, and a message e2 and a message e4 sent by the user E are displayed in the third page. The user E here may be the user who initiates the question message, and a message input box may also be displayed.

Reference is made to FIG. 4C and FIG. 7C, which is a schematic diagram of an application scenario. As shown in FIG. 4C, a question message and a reply message are displayed in the first page 41. The reply message includes a citation list and reply content. The reply content includes a first sentence, and the first sentence is generated according to citation content. The citation content in the first sentence includes chat message content with a chat robot. A citation identification 418 corresponding to the chat message content with the chat robot may be displayed at a preset position of the first sentence. The user may perform a first preset operation on the target citation identification 418, and the preview content 422 of the chat message content with the chat robot may be displayed in the form of a card. The user may perform a third preset operation on the preview content 422, to open a fourth page 712, as shown in FIG. 7C. The detailed content of the chat between the user E and the chat robot is displayed in the fourth page 712. The detailed content of the chat includes request information sent by the user E to the chat robot, and a message t1 sent by the chat robot according to the request information. The message t1 may be a message related to the request information extracted from a preset knowledge base. In addition, a plurality of classification resource identifications provided for the user, such as a classification resource 1, a classification resource 2, a classification resource 3, and a classification resource 4 as shown in FIG. 7C, may also be displayed in the fourth page 712, and the user may perform a trigger operation on any classification resource identification to acquire information about a target classification resource indicated by the trigger operation. A message input box may also be displayed.

In some application scenarios, the detailed content corresponding to the target citation content may be displayed in a new window.

Specifically, if the citation content is the content of the document or the message content of the chat with the contact, a first new window is displayed on a side of the window where the question message and the reply message are displayed, and the detailed content of the document or the chat with the contact is displayed in the first new window: if the citation content is the chat message content with the robot, the window where the question message and the reply message are displayed is switched to a second new window; and the detailed content of the chat with the robot is displayed in the second new window.

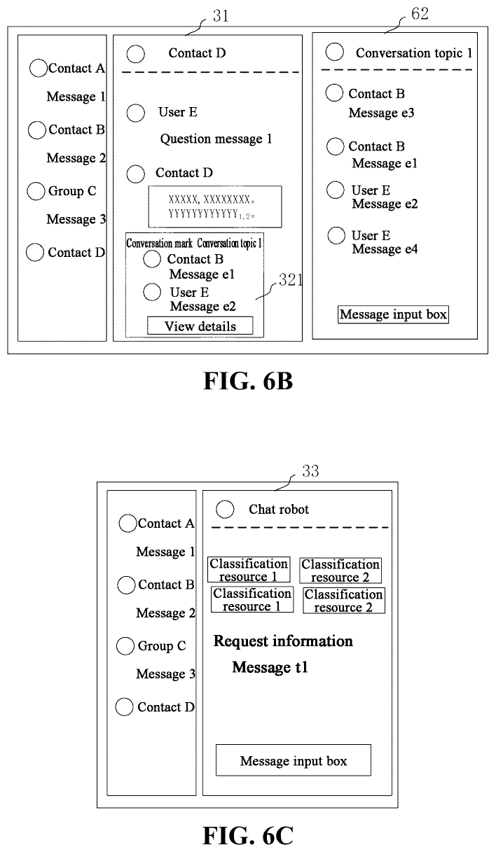

Reference is made to FIG. 3A and FIG. 6A, which is a schematic diagram of an application scenario. As shown in FIG. 3A, in an instant messaging application, an interactive message generated between a user and a virtual contact is displayed in a window 31, and the question message 311 and the reply message 312 arc displayed in the window 31. The reply message 312 includes a citation list 313 and reply content 314. The reply content 314 includes a first sentence 315, and the first sentence 315 is generated according to citation content S1 and S2. Citation identifications 316 and 317 corresponding to the citation content S1 and S2 respectively are displayed at the end of the first sentence 315. The citation content corresponding to the citation identification is document content. The user may perform a first preset operation on the citation identification 316, to display preview content 32 in the form of a card. A third preset operation may be performed on the preview content, and then a first new window 61 is displayed. As shown in FIG. 6A, detailed content corresponding to target citation content S1 is displayed in the first new window 61. The first new window 61 is arranged on a side of the window 31 where the question message and the reply message are displayed.

Reference is made to FIG. 3B and FIG. 6B, which is a schematic diagram of an application scenario. As shown in FIG. 3B, a question message and a reply message are displayed in a chat interface 31. The reply message includes a citation list and reply content. The reply content includes a first sentence, and the first sentence is generated according to citation content S1 and S2. Citation identifications 316 and 317 corresponding to the citation content S1 and S2 respectively are displayed at the end of the first sentence. The citation content S2 in the first sentence is message content of a chat with a contact. The user may perform a first preset operation on the target citation identification 317, and the preview content 321 of the target citation content S2 may be displayed in the form of a card. The user may perform a third preset operation on the preview content 321, to open a first new window 62, and the first new window is displayed on a side of the window 31 where the chat interface is displayed. A message input box may also be displayed.

As shown in FIG. 6B, a plurality of pieces of message content of a chat between the user E and the contact B are displayed in the first new window 62. As shown in FIG. 6B, a chat theme, a message e3 and a message e1 sent by the contact B, and a message e2 and a message c4 sent by the user E are displayed in the first new window 62. The user E here may be the user who initiates the question message.

Reference is made to FIG. 3C and FIG. 6C, which is a schematic diagram of an application scenario. As shown in FIG. 3C, a question message and a reply message are displayed in a chat interface 31. The reply message includes a citation list and reply content. The reply content includes a first sentence, and the first sentence is generated according to citation content. The citation content in the first sentence includes chat message content with a chat robot. A citation identification 318 corresponding to the chat message content with the chat robot may be displayed in the first sentence. The user may perform a first preset operation on the target citation identification 318, and the preview content 322 of the chat message content with the chat robot may be displayed in the form of a card. When the third preset operation performed by the user on the preview content 322 is received, a second new window 33 is displayed, as shown in FIG. 6C. The second new window 33 replaces the window 31 where the question message and the reply message are originally displayed. The second new window 33 displays message content of a chat with the chat robot. The message content of the chat includes request information sent by the user E to the chat robot and related content sent by the chat robot according to the request information. The related content may be content related to the request information extracted from a preset knowledge base.

In addition, a plurality of classification resource identifications provided for the user, such as a classification resource 1, a classification resource 2, a classification resource 3, and a classification resource 4 as shown in FIG. 6C, may also be displayed in the second new window 33, and the user may perform a trigger operation on any classification resource identification to acquire information about a target classification resource indicated by the trigger operation. A message input box may also be displayed.

In this embodiment, the process of displaying the detailed content corresponding to the target citation content through the third preset operation performed on the target citation identification or the preview information corresponding to the target citation identification is described, so that the user can open the detailed content corresponding to the citation content from the target citation identification or the preview information, thereby improving the efficiency of the user in acquiring the detailed content of the citation content.

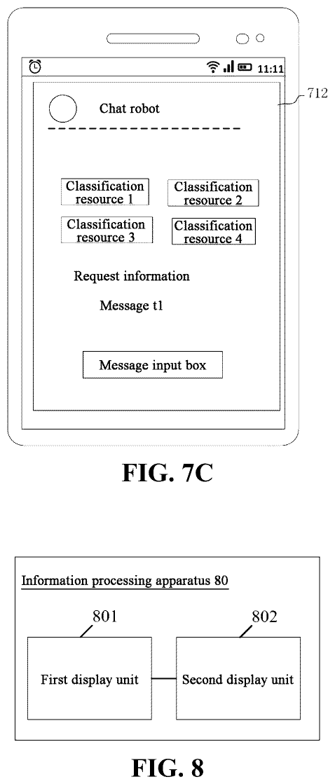

Corresponding to the information processing method in the embodiment of FIG. 1. FIG. 2, or FIG. 5 above. FIG. 8 is a schematic structural block diagram of an information processing apparatus according to an embodiment of the present disclosure. For case of explanation, only parts related to the embodiments of the present disclosure are shown. Referring to FIG. 8, the apparatus 80 includes: a first display unit 801 and a second display unit 802.

The first display unit 801 is configured to display a reply message sent by a virtual contact in response to a question message sent by a user to the virtual contact, where the reply message includes reply content for the question message and a citation identification, located in the reply content, of citation content used to generate the reply content.

The second display unit 802 is configured to display the citation content indicated by the citation identification in response to a first preset operation performed on the citation identification.

In some embodiments, the first display unit 801 is further configured to:

Display the reply message in the chat interface in response to the question message sent by the user to the virtual contact in the chat, where the chat interface is an interface for chatting with the virtual contact initiated by the user in the instant messaging application.

In some embodiments, a plurality of pieces of citation content exist, and the reply message further includes a citation list, where the citation list includes citation information corresponding to the plurality of pieces of citation content respectively.

In some embodiments, the citation list is located above the reply content; and

The plurality of pieces of citation information in the citation list are arranged horizontally or vertically in a preset order.

In some embodiments, the reply content includes at least one first sentence, the first sentence is generated according to corresponding citation content, and for each first sentence, a citation identification of the citation content corresponding to the first sentence is located at a preset position of the first sentence:

Alternatively, the reply content includes at least one first paragraph, the first paragraph is generated according to corresponding citation content, and for each first paragraph, a citation identification of the citation content corresponding to the first paragraph is located at a preset position of the first paragraph.

In some embodiments, a plurality of pieces of citation content exist, the citation identification includes citation identifications corresponding to the plurality of pieces of citation content respectively, and the second display unit 802 is further configured to:

Display target citation content indicated by a target citation identification in response to a first preset operation performed on the target citation identification; and highlight the target citation identification in the reply content.

In some embodiments, the second display unit 802 is further configured to:

Display preview content of the citation content in the form of a card; or

Display the citation content in the form of a pop-up window or a floating window.

In some embodiments, the display region of the citation content covers an interface where the question message and the reply message are located.

In some embodiments, the second display unit 802 is further configured to:

Cancel displaying the preview content in response to a second preset operation performed outside the preview content; or

Cancel displaying the citation content in response to a second preset operation performed outside the pop-up window or floating window.

In some embodiments, the citation content includes at least one of the following:

Document content, message content of a chat with a contact, chat message content with a chat robot, or email content.

In some embodiments, if the citation content is document content, the preview content includes: a document mark, a document title, document content for generating the reply content, and a latest update time;

If the citation content is message content of a chat with a contact, the preview content includes: a chat mark, a chat theme, and message content for generating the reply content; and

If the citation content is chat message content with a chat robot, the preview content includes: a chat robot mark, request information sent to the chat robot, and chat robot reply content used to generate the reply content. In some embodiments, the apparatus 80 further includes a third display unit (not shown in the figure), and the third display unit is configured to:

Display detailed content corresponding to the target citation content in response to a third preset operation performed on the target citation identification or the target citation content.

In some embodiments, the third display unit is further configured to:

Display the detailed content corresponding to the target citation content in a new window; or

Display the detailed content corresponding to the target citation content in a new page, where the new page covers the page where the question message and the reply message are displayed.

In some embodiments, the third display unit is further configured to:

If the citation content is the content of the document or the message content of the chat with the contact, display a first new window on a side of the window where the question message and the reply message are displayed, and display the detailed content of the document or the chat with the contact in the first new window; or

If the citation content is the chat message content with the robot, switch the window where the question message and the reply message are displayed to a second new window; and display the detailed content of the chat with the robot in the second new window.

In some embodiments, the detailed content of the document includes a title, a plurality of paragraphs of the document, and a link of the document:

The detailed content of the chat with the contact includes a theme of the chat, a plurality of pieces of message content, and a message input box; and

The detailed content of the chat with the robot includes a plurality of pieces of message content of the chat with the robot, a plurality of resource classifications, where each resource classification corresponds to a plurality of pieces of resource information and a message input box.

In order to implement the above embodiments, the embodiments of the present disclosure further provide an electronic device.

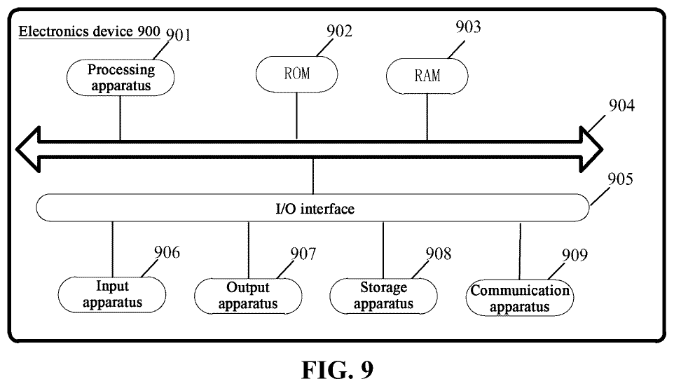

Referring to FIG. 9, it shows a schematic structural diagram of an electronic device 900 suitable for implementing the embodiments of the present disclosure, and the electronic device 900 may be a terminal device or a server. The terminal device may include, but is not limited to, mobile terminals such as a mobile phone, a notebook, a digital broadcast receiver, a personal digital assistant (abbreviated as PDA), a tablet computer, a portable media player (abbreviated as PMP), a vehicle-mounted terminal (such as a vehicle-mounted navigation terminal), and the like, and fixed terminals such as a digital TV, a desktop computer, and the like. The electronic device shown in FIG. 9 is only an example, and should not bring any limitation to the function and usage scope of the embodiments of the present disclosure.

As shown in FIG. 9, the electronic device 900 may include a processing apparatus (such as a central processing unit, a graphics processor, etc.) 901, which can perform various appropriate actions and processing according to a program stored in a read-only memory (abbreviated as ROM) 902 or a program loaded from a storage apparatus 908 into a random access memory (abbreviated as RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, a gyroscope, and the like: an output apparatus 907 including, for example, a liquid crystal display (abbreviated as LCD), a speaker, a vibrator, and the like: a storage apparatus 908 including, for example, a magnetic tape, a hard disk, and the like; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all the apparatuses shown. Alternatively, more or fewer apparatuses may be implemented or provided.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, and the computer program includes program codes for executing the methods shown in the flowcharts. In such an embodiment, the computer program may be downloaded and installed from a network through the communication apparatus 909, or installed from the storage apparatus 908, or installed from the ROM 902. When the computer program is executed by the processing apparatus 901, the above functions defined in the methods of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program, and the program may be used by or in combination with an instruction execution system, apparatus, or device. In the present disclosure, the computer-readable signal medium may include a data signal propagated in a baseband or as a part of a carrier, and computer-readable program codes are carried in the data signal. The data signal propagated in this manner may be in various forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit the program for use by or in combination with the instruction execution system, apparatus, or device. The program codes contained on the computer-readable medium may be transmitted by any suitable medium, including but not limited to: a wire, an optical cable. RF (radio frequency), etc., or any suitable combination thereof.

The above computer-readable medium may be included in the above electronic device, or may exist alone without being assembled into the electronic device.

The above computer-readable medium carries one or more programs, and when the one or more programs are executed by the electronic device, the electronic device is caused to execute the method as shown in the above embodiments.

The computer program codes for performing the operations of the present disclosure may be written in one or more programming languages or a combination thereof. The above programming languages include object-oriented programming languages such as Java. Smalltalk, and C++, and also conventional procedural programming languages such as “C” language or similar programming languages. The program codes may be executed entirely on a user's computer, executed partly on a user's computer, executed as a stand-alone software package, executed partly on a user's computer and partly on a remote computer, or executed entirely on a remote computer or a server. In the scenario involving the remote computer, the remote computer may be connected to the user's computer through any type of network, including a local area network (abbreviated as LAN) or a wide area network (abbreviated as WAN), or the connection may be made to an external computer (for example, through the internet using an internet service provider).

The flowcharts and block diagrams in the drawings illustrate the architecture, functionality, and operation of possible implementations of the system, method, and computer program product according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions marked in the blocks may also occur in a different order than those marked in the drawings. For example, two blocks shown in succession may, in fact, be executed substantially concurrently, or the two blocks may sometimes be executed in a reverse order, depending on the functionality involved. It should also be noted that, each block of the block diagrams and/or flowcharts and a combination of blocks in the block diagrams and/or flowcharts may be implemented by a dedicated hardware-based system that performs the specified functions or operations, or may also be implemented by a combination of dedicated hardware and computer instructions.

The units involved in the embodiments of the present disclosure may be implemented by software or hardware. The name of a unit does not constitute a limitation on the unit itself under certain circumstances. For example, the first acquiring unit may also be described as “a unit for acquiring at least two internet Protocol addresses”.

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), or the like.

In the context of the present disclosure, a machine-readable medium may be a tangible medium that may include or store a program for use by or in combination with an instruction executing system, apparatus or device. The machine-readable medium may be a machine-readable signal medium or a machine-readable storage medium. The machine-readable medium may include, but is not limited to, an electrical, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, according to one or more embodiments of the present disclosure, an information processing method is provided, including: displaying a reply message sent by a virtual contact in response to a question message sent by a user to the virtual contact, where the reply message includes reply content for the question message and a citation identification, located in the reply content, of citation content used to generate the reply content; and displaying the citation content indicated by the citation identification in response to a first preset operation performed on the citation identification.

According to one or more embodiments of the present disclosure, displaying the reply message sent by the virtual contact in response to the question message sent by the user to the virtual contact includes:

Displaying the reply message in a chat interface in response to the question message sent by the user to the virtual contact in the chat, where the chat interface is an interface for chatting with the virtual contact initiated by the user in an instant messaging application.

According to one or more embodiments of the present disclosure, a plurality of pieces of citation content exist, and the reply message further includes a citation list, where the citation list includes citation information corresponding to the plurality of pieces of citation content respectively.

According to one or more embodiments of the present disclosure, the citation list is located above the reply content; and

The plurality of pieces of citation information in the citation list are arranged horizontally or vertically in a preset order.

According to one or more embodiments of the present disclosure, the reply content includes at least one first sentence, the first sentence is generated according to corresponding citation content, and for each first sentence, a citation identification of the citation content corresponding to the first sentence is located at a preset position of the first sentence:

Alternatively, the reply content includes at least one first paragraph, the first paragraph is generated according to corresponding citation content, and for each first paragraph, a citation identification of the citation content corresponding to the first paragraph is located at a preset position of the first paragraph.

According to one or more embodiments of the present disclosure, a plurality of pieces of citation content exist, and the citation identification includes citation identifications corresponding to the plurality of pieces of citation content respectively; and displaying the preview information of the citation content indicated by the citation identification in response to the first preset operation performed on the citation identification includes:

Displaying target citation content indicated by a target citation identification in response to the first preset operation performed on the target citation identification; and highlighting the target citation identification in the reply content.

According to one or more embodiments of the present disclosure, displaying the citation content indicated by the citation identification includes:

Displaying preview content of the citation content in the form of a card; or

Displaying the citation content in the form of a pop-up window or a floating window.

According to one or more embodiments of the present disclosure, the display region of the citation content covers an interface where the question message and the reply message are located.

According to one or more embodiments of the present disclosure, the method further includes:

Canceling displaying the preview content in response to a second preset operation performed outside the preview content; or

Canceling displaying the citation content in response to a second preset operation performed outside the pop-up window or floating window.

According to one or more embodiments of the present disclosure, the citation content includes at least one of the following:

Document content, message content of a chat with a contact, chat message content with a chat robot, or email content.

According to one or more embodiments of the present disclosure, if the citation content is document content, the preview content includes: a document mark, a document title, document content for generating the reply content, and a latest update time;

If the citation content is message content of a chat with a contact, the preview content includes: a chat mark, a chat theme, and message content for generating the reply content; and

If the citation content is chat message content with a chat robot, the preview content includes: a chat robot mark, request information sent to the chat robot, and chat robot reply content used to generate the reply content.

According to one or more embodiments of the present disclosure, the method further includes:

Displaying detailed content corresponding to the target citation content in response to a third preset operation performed on the target citation identification or the target citation content.

According to one or more embodiments of the present disclosure, displaying the detailed content corresponding to the target citation content in response to the third preset operation performed on the target citation identification or the target citation content includes:

Displaying the detailed content corresponding to the target citation content in a new window; or

Displaying the detailed content corresponding to the target citation content in a new page, where the new page covers the page where the question message and the reply message are displayed.

According to one or more embodiments of the present disclosure, displaying the detailed content corresponding to the target citation content in the new window includes:

If the citation content is the content of the document or the message content of the chat with the contact, displaying a first new window on a side of the window where the question message and the reply message are displayed, and displaying the detailed content of the document or the chat with the contact in the first new window; or

If the citation content is the chat message content with the robot, switching the window where the question message and the reply message are displayed to a second new window, and displaying the detailed content of the chat with the robot in the second new window.

According to one or more embodiments of the present disclosure, the detailed content of the document includes a title, a plurality of paragraphs of the document, and a link of the document:

The detailed content of the chat with the contact includes a theme of the chat, a plurality of pieces of message content, and a message input box; and

The detailed content of the chat with the robot includes a plurality of pieces of message content of the chat with the robot, a plurality of resource classifications, where each resource classification corresponds to a plurality of pieces of resource information and a message input box.

In a second aspect, according to one or more embodiments of the present disclosure, an information processing apparatus is provided, including: a first display unit configured to display a reply message sent by a virtual contact in response to a question message sent by a user to the virtual contact, where the reply message includes reply content for the question message and a citation identification, located in the reply content, of citation content used to generate the reply content; and a second display unit configured to display the citation content indicated by the citation identification in response to a first preset operation performed on the citation identification.

According to one or more embodiments of the present disclosure, the first display unit is further configured to:

Display the reply message in a chat interface in response to the question message sent by the user to the virtual contact in the chat, where the chat interface is an interface for chatting with the virtual contact initiated by the user in an instant messaging application.

According to one or more embodiments of the present disclosure, a plurality of pieces of citation content exist, and the reply message further includes a citation list, where the citation list includes citation information corresponding to the plurality of pieces of citation content respectively.

According to one or more embodiments of the present disclosure, the citation list is located above the reply content; and

The plurality of pieces of citation information in the citation list are arranged horizontally or vertically in a preset order.

According to one or more embodiments of the present disclosure, the reply content includes at least one first sentence, the first sentence is generated according to corresponding citation content, and for each first sentence, a citation identification of the citation content corresponding to the first sentence is located at a preset position of the first sentence:

Alternatively, the reply content includes at least one first paragraph, the first paragraph is generated according to corresponding citation content, and for each first paragraph, a citation identification of the citation content corresponding to the first paragraph is located at a preset position of the first paragraph.

According to one or more embodiments of the present disclosure, a plurality of pieces of citation content exist, the citation identification includes citation identifications corresponding to the plurality of pieces of citation content respectively, and the second display unit is further configured to:

Display target citation content indicated by a target citation identification in response to a first preset operation performed on the target citation identification; and highlight the target citation identification in the reply content.

According to one or more embodiments of the present disclosure, the second display unit is further configured to:

Display preview content of the citation content in the form of a card; or

Display the citation content in the form of a pop-up window or a floating window.

According to one or more embodiments of the present disclosure, the display region of the citation content covers an interface where the question message and the reply message are located.

According to one or more embodiments of the present disclosure, the second display unit is further configured to:

Cancel displaying the preview content in response to a second preset operation performed outside the preview content; or

Cancel displaying the citation content in response to a second preset operation performed outside the pop-up window or floating window.

According to one or more embodiments of the present disclosure, the citation content includes at least one of the following:

Document content, message content of a chat with a contact, chat message content with a chat robot, or email content.

According to one or more embodiments of the present disclosure, if the citation content is document content, the preview content includes: a document mark, a document title, document content for generating the reply content, and a latest update time;

If the citation content is message content of a chat with a contact, the preview content includes: a chat mark, a chat theme, and message content for generating the reply content; and

If the citation content is chat message content with a chat robot, the preview content includes: a chat robot mark, request information sent to the chat robot, and chat robot reply content used to generate the reply content.

According to one or more embodiments of the present disclosure, the apparatus further includes a third display unit, and the third display unit is configured to:

Display detailed content corresponding to the target citation content in response to a third preset operation performed on the target citation identification or the target citation content.

According to one or more embodiments of the present disclosure, the third display unit is further configured to:

Display the detailed content corresponding to the target citation content in a new window; or

Display the detailed content corresponding to the target citation content in a new page, where the new page covers the page where the question message and the reply message are displayed.

According to one or more embodiments of the present disclosure, the third display unit is further configured to:

If the citation content is the content of the document or the message content of the chat with the contact, display a first new window on a side of the window where the question message and the reply message are displayed, and display the detailed content of the document or the chat with the contact in the first new window; or

If the citation content is the chat message content with the robot, switch the window where the question message and the reply message are displayed to a second new window, and display the detailed content of the chat with the robot in the second new window.

According to one or more embodiments of the present disclosure, the detailed content of the document includes a title, a plurality of paragraphs of the document, and a link of the document:

The detailed content of the chat with the contact includes a theme of the chat, a plurality of pieces of message content, and a message input box; and

The detailed content of the chat with the robot includes a plurality of pieces of message content of the chat with the robot, a plurality of resource classifications, where each resource classification corresponds to a plurality of pieces of resource information and a message input box.

In a third aspect, according to one or more embodiments of the present disclosure, an electronic device is provided, including: at least one processor and a memory;

The memory stores computer-executable instructions; and

The at least one processor executes the computer-executable instructions stored in the memory to cause the at least one processor to execute the information processing method according to the first aspect and various possible designs of the first aspect.

In a fourth aspect, according to one or more embodiments of the present disclosure, a computer-readable storage medium is provided, the computer-readable storage medium stores computer-executable instructions, and when a processor executes the computer-executable instructions, the information processing method according to the first aspect and various possible designs of the first aspect is implemented.

In a fifth aspect, according to one or more embodiments of the present disclosure, a computer program product is provided, including a computer program, and when the computer program is executed by a processor, the information processing method according to the first aspect and various possible designs of the first aspect is implemented.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept. For example, the technical solution formed by replacing the above features with technical features with similar functions disclosed in the present disclosure (but not limited to).

In addition, although operations are depicted in a particular order, this should not be understood as requiring that such operations be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

I/We claim:

1. An information processing method, comprising:
in response to a question message to a virtual contact, displaying a reply message sent by the virtual contact, wherein the reply message comprises reply content for the question message and a citation identification, located in the reply content, of citation content used to generate the reply content; and
in response to a first preset operation performed on the citation identification, displaying the citation content indicated by the citation identification.

2. The method according to claim 1, wherein in response to the question message to the virtual contact, displaying the reply message sent by the virtual contact comprises:
in response to the question message to the virtual contact in a chat, displaying the reply message in a chat interface, wherein the chat interface is an interface for chatting with the virtual contact in an instant messaging application.

3. The method according to claim 1, wherein a plurality of pieces of citation content exist, and the reply message further comprises a citation list, wherein the citation list comprises citation information corresponding to the plurality of pieces of citation content respectively.

4. The method according to claim 3, wherein the citation list is located above the reply content; and
a plurality of pieces of citation information in the citation list are arranged horizontally or vertically in a preset order.

5. The method according to claim 1, wherein the reply content comprises at least one first sentence, the first sentence is generated according to corresponding citation content, and for each first sentence, a citation identification of the citation content corresponding to the first sentence is located at a preset position of the first sentence; or
the reply content comprises at least one first paragraph, the first paragraph is generated according to corresponding citation content, and for each first paragraph, a citation identification of the citation content corresponding to the first paragraph is located at a preset position of the first paragraph.

6. The method according to claim 1, wherein a plurality of pieces of citation content exist, the citation identification comprises citation identifications corresponding to the plurality of pieces of citation content respectively, and in response to the first preset operation performed on the citation identification, displaying the citation content indicated by the citation identification comprises:
in response to the first preset operation performed on a target citation identification, displaying target citation content indicated by the target citation identification; and
highlighting the target citation identification in the reply content.

7. The method according to claim 1, wherein displaying the citation content indicated by the citation identification comprises:
displaying preview content of the citation content in the form of a card; or
displaying the citation content in the form of a pop-up window or a floating window.

8. The method according to claim 7, wherein a display region of the citation content covers an interface where the question message and the reply message are located.

9. The method according to claim 8, wherein the method further comprises:
in response to a second preset operation performed outside the preview content, canceling displaying the preview content; or
in response to a second preset operation performed outside the pop-up window or floating window, canceling displaying the citation content.

10. The method according to claim 1, wherein the citation content comprises at least one of:
document content, message content of a chat with a contact, chat message content with a chat robot, or email content.

11. The method according to claim 7, wherein
in response to the citation content being document content, the preview content comprises at least one of: a document mark, a document title, document content for generating the reply content, or a latest update time;
in response to the citation content being message content of a chat with a contact, the preview content comprises at least one of: a chat mark, a chat theme, or message content for generating the reply content; and
in response to the citation content being chat message content with a chat robot, the preview content comprises at least one of: a chat robot mark, request information sent to the chat robot, and chat robot reply content used to generate the reply content.

12. The method according to claim 6, wherein the method further comprises:
in response to a third preset operation performed on the target citation identification or the target citation content, displaying detailed content corresponding to the target citation content.

13. The method according to claim 12, wherein in response to the third preset operation performed on the target citation identification or the target citation content, displaying the detailed content corresponding to the target citation content comprises:
displaying the detailed content corresponding to the target citation content in a new window; or
displaying the detailed content corresponding to the target citation content in a new page, wherein the new page covers a page where the question message and the reply message are displayed.

14. The method according to claim 13, wherein displaying the detailed content corresponding to the target citation content in the new window comprises:
in response to the citation content being content of a document or message content of a chat with a contact, displaying a first new window on a side of a window where the question message and the reply message are displayed, the first new window displaying detailed content of the document or the chat with the contact; or
in response to the citation content being chat message content with a robot, switching the window where the question message and the reply message are displayed to a second new window, the second new window displaying detailed content of a chat with the robot.

15. The method according to claim 14, wherein
the detailed content of the document comprises a title, a plurality of paragraphs of the document, and a link of the document;
the detailed content of the chat with the contact comprises a theme of the chat, a plurality of pieces of message content, and a message input box; and
the detailed content of the chat with the robot comprises a plurality of pieces of message content of the chat with the robot, and a plurality of resource classifications, wherein each resource classification corresponds to a plurality of pieces of resource information and a message input box.

16. An electronic device, comprising:
one or more processors;
a storage device for storing one or more programs, wherein,
the one or more programs, when executed by the one or more processors, cause the one or more processors to:
in response to a question message to a virtual contact, display a reply message sent by the virtual contact, wherein the reply message comprises reply content for the question message and a citation identification, located in the reply content, of citation content used to generate the reply content; and
in response to a first preset operation performed on the citation identification, display the citation content indicated by the citation identification.

17. The device according to claim 16, wherein the one or more programs causing the one or more processors to in response to the question message to the virtual contact, display the reply message sent by the virtual contact comprise instructions to:
in response to the question message to the virtual contact in a chat, display the reply message in a chat interface, wherein the chat interface is an interface for chatting with the virtual contact in an instant messaging application.

18. The device according to claim 16, wherein a plurality of pieces of citation content exist, and the reply message further comprises a citation list, wherein the citation list comprises citation information corresponding to the plurality of pieces of citation content respectively.

19. The device according to claim 18, wherein the citation list is located above the reply content; and
a plurality of pieces of citation information in the citation list are arranged horizontally or vertically in a preset order.

20. A non-transitory storage medium containing computer-executable instructions, wherein the computer-executable instructions, when executed by one or more computer processors, are used to cause the one or more computer processors to:
in response to a question message to a virtual contact, display a reply message sent by the virtual contact, wherein the reply message comprises reply content for the question message and a citation identification, located in the reply content, of citation content used to generate the reply content; and
in response to a first preset operation performed on the citation identification, display the citation content indicated by the citation identification.
